(19) United States
(12) Patent Application Publication
(10) Pub. No.: US 2026/0368834 A1
(43) Pub. Date: Nov. 19, 2026

(54) WRITTEN RESPONSE DRAFT PREPARATION SUPPORT DEVICE, NOTIFICATION DOCUMENT DRAFT PREPARATION SUPPORT DEVICE, PATENT-RELATED DOCUMENT PREPARATION SUPPORT SYSTEM, WRITTEN RESPONSE DRAFT PREPARATION SUPPORT METHOD, NOTIFICATION DOCUMENT DRAFT PREPARATION SUPPORT METHOD, AND PROGRAM

(71) Applicant: Resonac Corporation, Tokyo (JP)

(72) Inventor: Ryuichi MITSUMOTO, Tokyo (JP)

(21) Appl. No.: 19/477,633

(22) PCT Filed: Apr. 24, 2024
(86) PCT No.: PCT/JP2024/016171

§ 371 Date: Oct. 22, 2025

(30) Foreign Application Priority Data
Apr. 26, 2023 (JP) 2023-072002

(51) Int. Cl. G06Q 50/18; G06F 16/353

(52) U.S. Cl. CPC G06Q 50/184; G06F 16/353

(57) ABSTRACT

A written response draft preparation support device for supporting preparation work of a patent-related document, the written response draft preparation support device that includes: a first database configured to store at least one of information on examination standards, examination guidelines, court cases, or judicial precedents; a second database configured to store information on an examination history of an application; a written response draft preparation part configured to prepare a draft of a written response based on a newly obtained application document and a notification document from a patent office by using a large-scale language model which has learned a relationship between an application document, a notification document from the patent office, and a written response with respect to the notification document which are included in the information on the examination history; and a display controller configured to display the prepared draft.

### TECHNICAL FIELD

The present disclosure relates to a written response draft preparation support device, a notification document draft preparation support device, a patent-related document preparation support system, a written response draft preparation support method, a notification document draft preparation support method, and a program.

### BACKGROUND ART

For example, it has been desired to more appropriately estimate types of issues that are expected to be raised in a notice of reasons for refusal with respect to a new patent description, by processing information on past notices of reasons for refusal on an issue-by-issue basis. There is known a technique for supporting evaluation and preparation work of application documents by searching a patent examination database, in which, regarding the description of the scope of claims in the application documents, information associating a past application to which a request for examination has been made, with a notice of reasons for refusal issued for the application requested for the examination is stored (for example, see Patent Document 1).

### RELATED ART DOCUMENTS

### Patent Documents

Patent Document 1: Japanese Patent No. 5629976

### SUMMARY OF THE INVENTION

### Problem to be Solved by the Invention

Preparation of patent-related documents such as a notice of reasons for refusal, a draft of written amendment, and a written opinion requires a great deal of the knowledge and effort of a person. The technology disclosed in Patent Document 1 does not solve the issue that preparation of patent-related documents such as a notice of reasons for refusal, a draft of written amendment, and a written opinion requires a great deal of the knowledge and effort of a person.

According to the present disclosure, a written response draft preparation support device, a notification document draft preparation support device, a patent-related document preparation support system, a written response draft preparation support method, a notification document draft preparation support method, and a program, are provided for reducing the knowledge and effort required of a person to prepare patent-related documents.

### Means for Solving the Problems

The present disclosure has the following configuration.

[1] A written response draft preparation support device for supporting preparation work of a patent-related document, including:
a first database configured to store at least one of information on examination standards, examination guidelines, court cases, or judicial precedents;
a second database configured to store information on an examination history of an application;
a written response draft preparation part configured to prepare a draft of a written response to be sent from a patent office based on a newly obtained application document and a notification document, by using a large-scale language model which has learned a relationship between an application document, a notification document from the patent office, and a written response with respect to the notification document which are included in the information on the examination history; and
a display controller configured to display the prepared draft.

[2] The written response draft preparation support device according to [1], wherein the large-scale language model learns the relationship between the application document, the notification document from the patent office, and the written response with respect to the notification document, included in the information on the examination history, after classification based on a type of raised issue in the notification document from the patent office.

[3] The written response draft preparation support device according to [2], wherein
the type of raised issue is one or a combination of novelty, inventive step, applicability to invention, industrial applicability, clarity, and support requirements.

[4] The written response draft preparation support device according to any one of [1] to [3], wherein
the draft of the written response is at least either of a draft of a written opinion or a draft of a written amendment.

[5] The written response draft preparation support device according to any one of [1] to [4], further including:
an assessment-rate estimator configured to estimate a patent assessment rate of the draft of the written response by using an assessment-rate estimation model that has learned a relationship between the information on the examination history and an assessment result.

[6] A notification document draft preparation support device for supporting preparation work of a patent-related document, the notification document draft preparation support device including:
a first database configured to store at least one of information on examination standards, examination guidelines, court cases, or judicial precedents;
a second database configured to store information on an examination history of an application;
a notification document draft preparation part configured to prepare a draft of a notification document to be sent from a patent office, based on an application document and a written response which are newly obtained, by using a learned large-scale language model which has learned a relationship between an application document, a notification document from the patent office, and a written response with respect to the notification document which are included in information on an examination history; and
a display controller configured to display the prepared draft.

[7] A patent-related document preparation support system provided with a written response draft preparation support device and a notification document draft preparation support device which are for supporting preparation work of a patent-related document, including:
a first database configured to store at least one of information on examination standards, examination guidelines, court cases, or judicial precedents;
a second database configured to store information on an examination history of an application;
a written response draft preparation part configured to prepare a draft of a written response from both a newly obtained application document and a notification document from a patent office by using a first large-scale language model which has learned a relationship between an application document, a notification document from a patent office, and a written response with respect to the notification document which are included in the information on the examination history;
a notification document draft preparation part configured to prepare a draft of a notification document to be sent from the patent office, based on an application document and a written response which are newly obtained, by using a second learned large-scale language model that has learned the relationship between the application document, the notification document from the patent office, and the written response with respect to the notification document which are included in the information on the examination history; and
a display controller configured to display the prepared draft, and
the written response draft preparation part is configured to prepare a draft of a written response based on the application document and the draft of the notification document to be sent from the patent office prepared by the notification document draft preparation part, which are newly obtained.

[8] The patent-related document preparation support system according to [7], wherein
the notification document draft preparation part is configured to prepare a draft of a notification document to be sent from the patent office, based on the application document and the draft of the written response prepared by the written response draft preparation part, which are newly obtained.

[9] A written response draft preparation support method performed by a written response draft preparation support device supporting preparation work of a patent-related document, the written response draft preparation support device being provided with a first database configured to store at least one of information on examination standards, examination guidelines, court cases, or judicial precedents, and a second database configured to store information on an examination history of an application, the written response draft preparation support method, including:
a step of preparing a draft of a written response from both a newly obtained application document and a notification document from a patent office by using a large-scale language model which has learned a relationship between an application document, a notification document from the patent office, and a written response with respect to the notification document which are included in the information on the examination history; and
a step of displaying the prepared draft.

[10] A notification document draft preparation support method performed by a notification document draft preparation support device supporting preparation work of a patent-related document, the notification document draft preparation support device being provided with a first database storing at least one of information on examination standards, examination guidelines, court cases, or judicial precedents, and a second database storing information on an examination history of an application, the notification document draft preparation support method, including:
a step of preparing a draft of a notification document to be sent from a patent office based on an application document and a written response which are newly obtained, by using a learned large-scale language model which has learned a relationship between an application document, a notification document from the patent office, and a written response with respect to the notification document which are included in information on an examination history; and
a step of displaying the prepared draft.

[11] A program which causes a written response draft preparation support device supporting preparation work of a patent-related document, the written response draft preparation support device being provided with a first database storing at least one of information on examination standards, examination guidelines, court cases, or judicial precedents, and a second database storing information on an examination history of an application, to function as
a written response draft preparation part configured to prepare a draft of a written response based on an application document and a notification document from the patent office which are newly obtained, by using a learned large-scale language model which has learned a relationship between an application document, a notification document from the patent office, and a written response with respect to the notification document which are included in information on an examination history, and
a display controller configured to display the prepared draft.

[12] A program which causes a notification document draft preparation support device supporting preparation work of a patent-related document, the notification document draft preparation support device being provided with a first database storing at least one of information on examination standards, examination guidelines, court cases, or judicial precedents, and a second database storing information on an examination history of an application, to function as
a notification document draft preparation part configured to prepare a draft of a notification document to be sent from the patent office, based on an application document and a written response which are newly obtained, by using a large-scale language model which has learned a relationship between an application document, a notification document from the patent office, and a written response with respect to the notification document which are included in the information on the examination history, and
a display controller configured to display the prepared draft.

### Advantageous Effects of the Invention

According to the present disclosure, it is possible to reduce the knowledge and effort required of a person to prepare patent-related documents.

### BRIEF DESCRIPTION OF THE DRAWINGS

FIG. 1 is a configuration diagram of an example of a patent-related document preparation support system according to the present embodiment.

FIG. 2 is a hardware configuration diagram of an example of a computer according to the present embodiment.

FIG. 3 is a functional configuration diagram of an example of a written response draft preparation support device according to the present embodiment.

FIG. 4 is a functional configuration diagram of an example of a notification document draft preparation support device according to the present embodiment.

FIG. 5 is a flowchart of an example of processing by the written response draft preparation support device according to the present embodiment.

FIG. 6 is an image diagram of an example of the processing of the written response draft preparation support device according to the present embodiment, for preparing a draft of a written response.

FIG. 7 is a flowchart of an example of processing by the notification document draft preparation support device according to the present embodiment.

FIG. 8 is an image diagram of an example of the processing of the notification document draft preparation support device according to the present embodiment, for preparing a draft of a notification document.

FIG. 9 is an explanatory diagram of an example of using the processes of the written response draft preparation support device and the notification document draft preparation support device in combination.

### DETAILED DESCRIPTION OF THE INVENTION

Next, an embodiment of the present invention will be described in detail. The present invention is not limited to the following embodiment.

### <System Configuration>

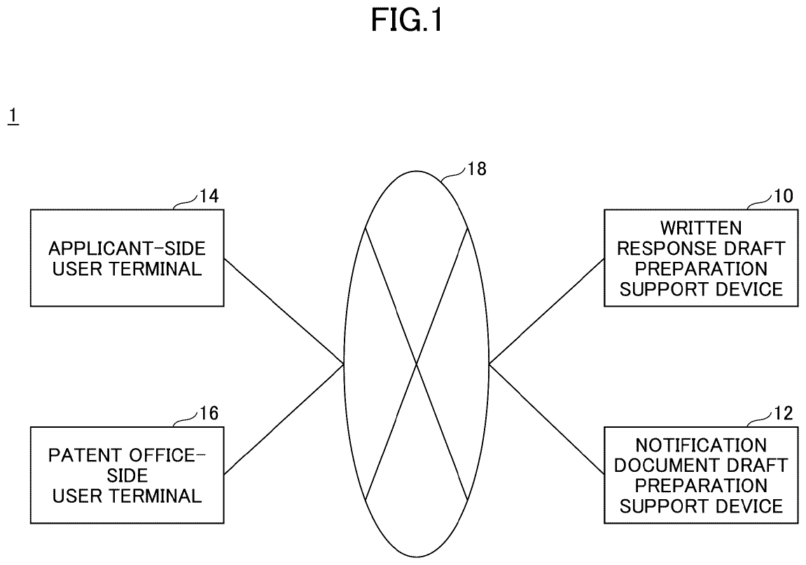

FIG. 1 is a configuration diagram of an example of a patent-related document preparation support system 1 according to the present embodiment. The patent-related document preparation support system 1 of FIG. 1 includes a written response draft preparation support device 10, a notification document draft preparation support device 12, an applicant-side user terminal 14, and a patent office-side user terminal 16. The written response draft preparation support device 10, the notification document draft preparation support device 12, the applicant-side user terminal 14, and the patent office-side user terminal 16 are connected for data communication via a communication network 18 such as a local area network (LAN) or the Internet.

The applicant-side user terminal 14 is an information processor such as a PC, a tablet terminal, or a smartphone operated by a user (hereinafter referred to as an applicant-side user) representing the applicant's side (for example, a person in charge at the intellectual property department or a person in charge at a patent law firm). The patent office-side user terminal 16 is an information processor such as a PC, a tablet terminal, or a smartphone operated by a user (hereinafter referred to as a patent office-side user) representing the patent office's side (e.g., examiner or hearing examiner).

The written response draft preparation support device 10 supports preparation work of a written response (for example, written amendment and written opinions) included in a patent-related document of the applicant side, according to an operation received by the applicant-side user terminal 14 from the applicant-side user. The written response draft preparation support device 10 prepares a draft of a written response of the applicant side by using a large-scale language model (hereinafter also referred to as LLM) learned as described in the following. The written response draft preparation support device 10 is an information processor such as a PC or a workstation. The LLM is a natural language processing model learned by using a large amount of text data. For example, the LLM can be adapted to natural language processing such as text generation by fine-tuning a previously learned model. For example, ChatGPT is an example of the LLM.

The notification document draft preparation support device 12 supports preparation work of a notification document (for example, a notice of reasons for refusal and a written decision of refusal, etc.) included in a patent-related document on the patent office side in accordance with an operation received by the patent office-side user terminal 16 from a patent office-side user. The notification document draft preparation support device 12 creates a draft of a notification document on the patent office side by using the LLM trained as described in the following. The notification document draft preparation support device 12 is an information processor such as a PC or a workstation.

In the patent-related document preparation support system 1 according to the present embodiment, personnel dependency in the patent-related document can be reduced by supporting creation of the patent-related document by using the trained LLM, as described in the following. In addition, the patent-related document preparation support system 1 according to the present embodiment can reduce the knowledge and effort required of a person to prepare patent-related documents.

Furthermore, the patent-related document preparation support system 1 according to the present embodiment can reduce errors in examination and trial on the patent office side, thereby contributing to shortening the examination period and ensuring the long-term stability of granted patents.

The patent-related document preparation support system 1 as illustrated in FIG. 1 is an example. The patent-related document preparation support system 1 has various system configuration examples according to applications and purposes.

For example, the written response draft preparation support device 10 and the notification document draft preparation support device 12 may be implemented by a plurality of computers or may be implemented as a cloud computing service. The written response draft preparation support device 10 and the notification document draft preparation support device 12 may be integrated.

### <Hardware Configuration>

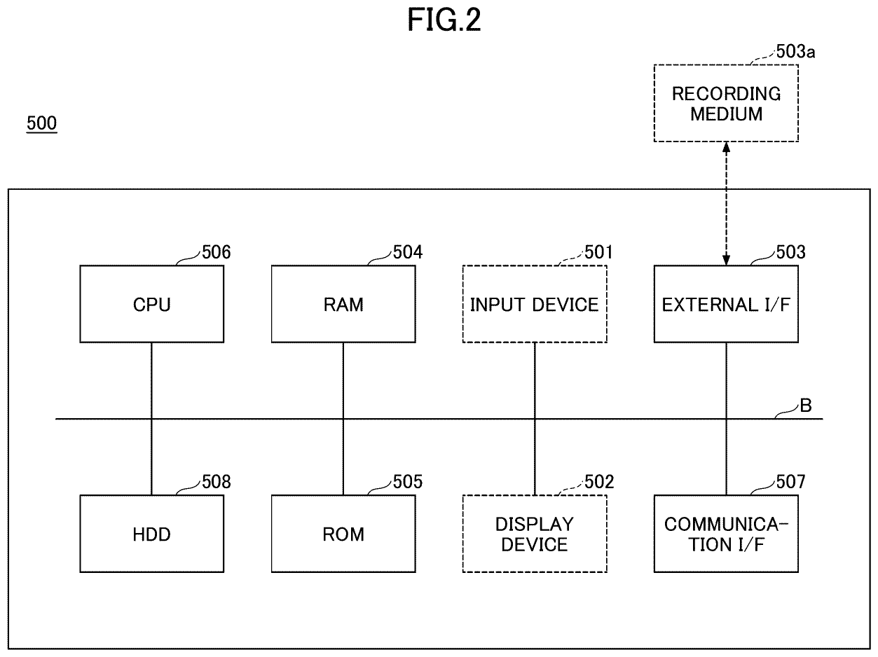

The written response draft preparation support device 10, the notification document draft preparation support device 12, the applicant-side user terminal 14, and the patent office-side user terminal 16 as illustrated in FIG. 1 are implemented by, for example, a computer 500 having the hardware configuration as illustrated in FIG. 2.

FIG. 2 is a hardware configuration diagram of an example of the computer 500 according to the present embodiment. The computer 500 as illustrated in FIG. 2 includes an input device 501, a display device 502, an external I/F 503, a RAM 504, a ROM 505, a CPU 506, a communication I/F 507, and an HDD 508, which are connected to each other by a bus B. The input device 501 and the display device 502 may be used in a state connected to the computer 500.

The input device 501 includes a touch panel, operation keys and buttons, a keyboard, a mouse, and the like used by a user to input various signals. The display device 502 includes a display such as a liquid crystal display or an organic EL display for displaying a screen, and a speaker for outputting sound data such as voice and sound. The communication I/F 507 is an interface for the computer 500 to perform data communication.

The HDD 508 is an example of a nonvolatile storage device for storing programs and data. The stored programs and data include an OS, which is basic software that controls the entire computer 500, and applications that provide various functions on the OS. In place of the HDD 508, the computer 500 may use a drive device (for example, a solid-state drive: SSD) that uses a flash memory as a storage medium.

The external I/F 503 is an interface for connecting with an external device. The external device includes a recording medium 503a. Thus, the computer 500 can read and/or write to the recording medium 503a via the external I/F 503. The recording medium 503a includes a flexible disk, a CD, a DVD, an SD memory card, a USB memory, and the like.

The ROM 505 is an example of a nonvolatile semiconductor memory (storage device) that can hold programs and data even when the power is turned off. The ROM 505 stores programs and data such as BIOS, OS settings, and network settings that are executed when the computer 500 is started. The RAM 504 is an example of a volatile semiconductor memory (storage device) for temporarily storing programs and data.

The CPU 506 is a computing device that reads programs and data from the storage devices such as the ROM 505 and the HDD 508 into the RAM 504 and executes processing to realize control and functions of the entire computer 500. By executing programs, the computer 500 according to the present embodiment can achieve various functions of the written response draft preparation support device 10, the notification document draft preparation support device 12, the applicant-side user terminal 14, and the patent office-side user terminal 16, which will be described in the following. The CPU 506 may read and execute a program from the recording medium 503a in which the program is stored via the external I/F 503. Alternatively, the CPU 506 may read and execute a program from another network by data communication via the communication I/F 507.

### <Functional Configuration>

The configuration of the patent-related document preparation support system 1 according to the present embodiment will be described.

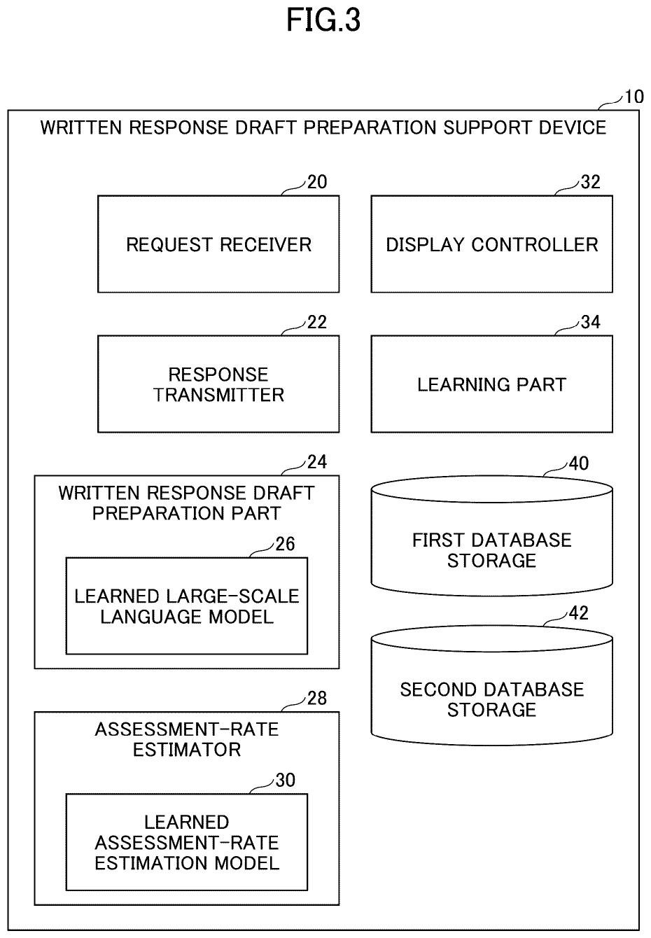

FIG. 3 is a functional configuration diagram of an example of the written response draft preparation support device 10 according to the present embodiment. The configuration diagram of FIG. 3 accordingly omits portions unnecessary for the description of the present embodiment.

The written response draft preparation support device 10 as illustrated in FIG. 3 includes a request receiver 20, a response transmitter 22, a written response draft preparation part 24, a learned large-scale language model 26, an assessment-rate estimator 28, a learned assessment-rate estimation model 30, a display controller 32, a learning part 34, a first database storage 40, and a second database storage 42.

The request receiver 20 receives a processing request based on an operation received by the applicant-side user terminal 14 from the applicant-side user. The response transmitter 22 transmits a response to the processing request received by the request receiver 20 to the applicant-side user terminal 14.

The written response draft preparation part 24 prepares a draft of a written response by using the learned large-scale language model 26.

The learned large-scale language model 26 has learned, for example, a relationship between the application document, the notification document from the patent office, and the written response with respect to the notification document, included in the information of the examination history.

The assessment-rate estimator 28 estimates an assessment rate such as a patent assessment rate of the draft of the written response prepared by the written response draft preparation part 24 by using a learned assessment-rate estimation model 30. The learned assessment-rate estimation model 30 has learned, for example, a relationship between information on an examination history and an assessment result.

The display controller 32 controls the applicant-side user terminal 14 to display a screen of a response to a processing request received by the request receiver 20. The learning part 34 uses the information of the first database storage 40 and the second database storage 42 to learn the learned large-scale language model 26 and the learned assessment-rate estimation model 30.

The first database storage 40 stores at least one of information on examination standards, examination guidelines, court cases, or judicial precedents. The judicial precedents are judgments of the Supreme Court. The court cases are judgments of high courts or district courts other than the Supreme Court. A second database storage 42 stores information on the examination history of an application. The information on the examination history of an application includes information necessary for learning a relationship between an application document, a notification document sent from the patent office with respect to the application document, and a written response sent from the applicant with respect to the notification document. The second database storage 42 may use a database that allows free search and inquiry of industrial property gazettes related to industrial property rights such as patents, utility models, designs, and trademarks. The information stored in the first database storage 40 and the second database storage 42 may be changed according to national patent examination practices. The national patent examination practices may be practices or customs of the national patent examination.

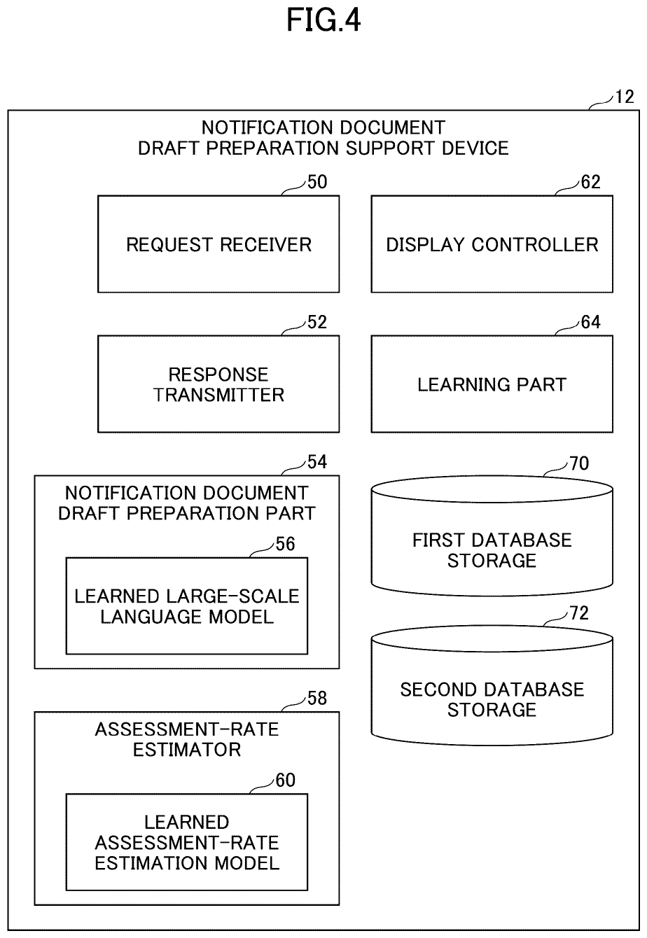

FIG. 4 is a functional configuration diagram of an example of the notification document draft preparation support device 12 according to the present embodiment. The configuration diagram of FIG. 4 accordingly omits parts unnecessary for the description of the present embodiment.

The notification document draft preparation support device 12 as illustrated in FIG. 4 includes a request receiver 50, a response transmitter 52, a notification document draft preparation part 54, a learned large-scale language model 56, an assessment-rate estimator 58, a learned assessment-rate estimation model 60, a display controller 62, a learning part 64, a first database storage 70, and a second database storage 72.

The request receiver 50 receives a request for processing based on the operation received by the patent office-side user terminal 16 from the patent office-side user. The response transmitter 52 transmits a response to the request for processing received by the request receiver 50 to the patent office-side user terminal 16.

The notification document draft preparation part 54 prepares a draft of a notification document from the patent office by using the learned large-scale language model 56.

The learned large-scale language model 56 has learned, for example, the relationship between the application document, the notification document from the patent office, and the written response with respect to the notification document, included in the information on the examination history.

When the applicant is notified of the draft of the notification document prepared by the notification document draft preparation part 54, the assessment-rate estimator 58 estimates, by using the learned assessment-rate estimation model 60, an assessment rate such as the patent assessment rate by a subsequent procedure. The learned assessment-rate estimation model 60 has learned, for example, the relationship between the information on the examination history and the assessment result.

The display controller 62 controls the patent office-side user terminal 16 to display a screen of a response to a processing request received by the request receiver 50. The learning part 64 uses information of the first database storage 70 and the second database storage 72 to learn the learned large-scale language model 56 and the learned assessment-rate estimation model 60.

The first database storage 70 stores at least one of information on examination standards, examination guidelines, court cases, or judicial precedents. The second database storage 72 stores information on an examination history of an application. The information on the examination history of an application includes information necessary for learning a relationship between an application document, a notification document notified by the patent office with respect to the application document, and a written response submitted by the applicant with respect to the notification document.

### <Processing>

Processes of the written response draft preparation support device 10 and the notification document draft preparation support device 12 of the patent-related document preparation support system 1 according to the present embodiment will be described in the following.

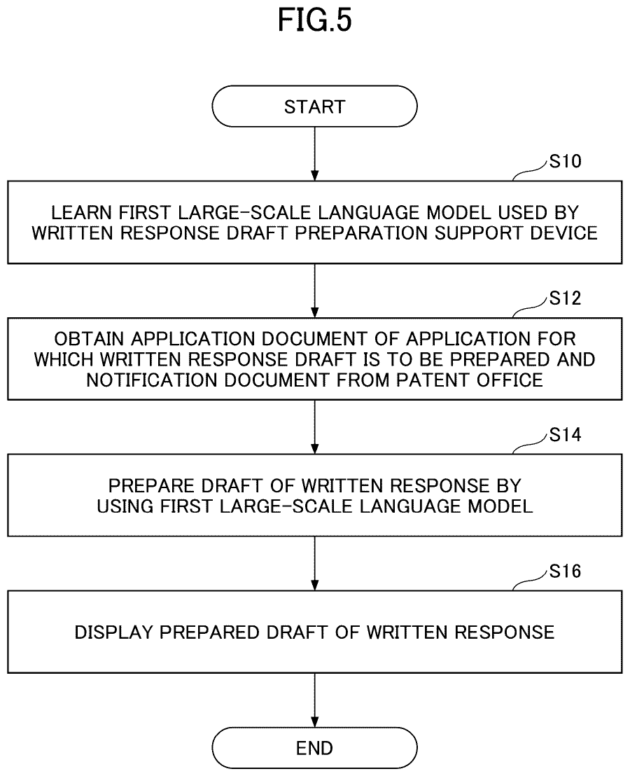

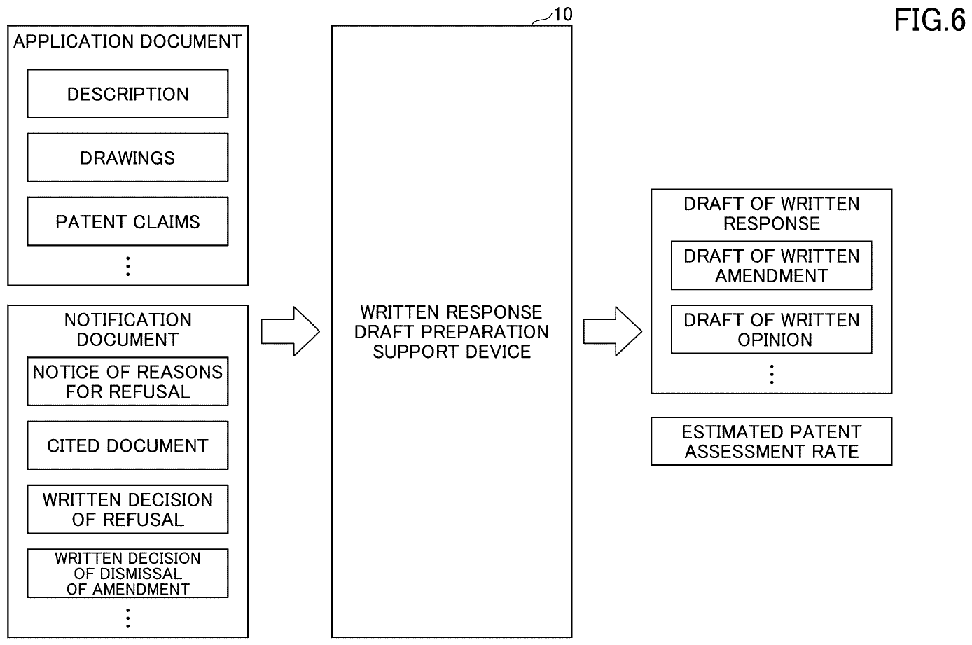

FIG. 5 is a flowchart of an example of processing by the written response draft preparation support device 10 according to the present embodiment. FIG. 6 is an image diagram of an example of processing by which the written response draft preparation support device 10 according to the present embodiment prepares a draft of the written response.

In step S10, the learning part 34 of the written response draft preparation support device 10 learns the learned large-scale language model 26 (an example of a first large-scale language model) to be used in the written response draft preparation part 24. The learning part 34 uses at least one of the information on examination standards, examination guidelines, court cases, or judicial precedents stored in the first database storage 40, and the information on the examination history of past applications stored in the second database storage 42, to cause the learned large-scale language model 26 to learn the relationship between the application document, the notification document notified by the patent office with respect to the application document, and the written response submitted by the applicant with respect to the notification document. The learned large-scale language model 26 learns to output the draft of the written response submitted by the applicant with respect to the notification document when the application document and the notification document notified by the patent office with respect to the application document are input.

The processing of making the learned large-scale language model 26 learn in step S10 may be performed outside the written response draft preparation support device 10. The first database storage 40 and the second database storage 42 may be provided outside the written response draft preparation support device 10.

Furthermore, the processing of making the learned large-scale language model 26 learn in step S10 may be performed for each type of raised issue in the notification document after classifying the teaching data according to the type of raised issue in the notification document from the patent office. The type of raised issue in the notification document is one or a combination of novelty, inventive step, applicability to invention, industrial applicability, clarity, and support requirements.

When the applicant-side user operates the applicant-side user terminal 14 and designates an application for which a draft of the written response is to be prepared, the written response draft preparation part 24 of the written response draft preparation support device 10 starts processing in step S12.

In step S12, the written response draft preparation part 24 obtains the application document of the application for which a draft of the written response is to be prepared and the notification document from the patent office. In step S14, the written response draft preparation part 24 prepares a draft of the written response, for example, as illustrated in FIG. 6.

As illustrated in FIG. 6, the written response draft preparation part 24 of the written response draft preparation support device 10 prepares a draft of the written response by using the learned large-scale language model 26, from both the application document and the notification document obtained in step S12. The learned large-scale language model 26 outputs a draft of the written response when the application document and the notification document notified from the patent office side to the application document are input.

The application document obtained in step S12 includes, for example, a description, drawings, and patent claims. The notification document from the patent office is, for example, a notice of reasons for refusal, a written decision of refusal, or a written decision of dismissal of amendment. The notification document from the patent office may include a cited document. The draft of the written response prepared in step S14 is, for example, at least either of a draft of written amendment or a draft of written opinion.

Furthermore, the assessment-rate estimator 28 of the written response draft preparation support device 10 may estimate an assessment rate (estimated patent assessment rate in FIG. 6), such as a patent assessment rate of the draft of the written response prepared by the written response draft preparation part 24, by using the learned assessment-rate estimation model 30.

In step S16, the display controller 32 of the written response draft preparation support device 10 causes the applicant-side user terminal 14 to display the draft of the written response prepared in step S14. The display controller 32 may also cause the estimated patent assessment rate estimated by the assessment-rate estimator 28 to be displayed. The patent-related document preparation support system 1 according to the present embodiment can reduce the knowledge and effort required of the applicant-side user to prepare a draft of a written response.

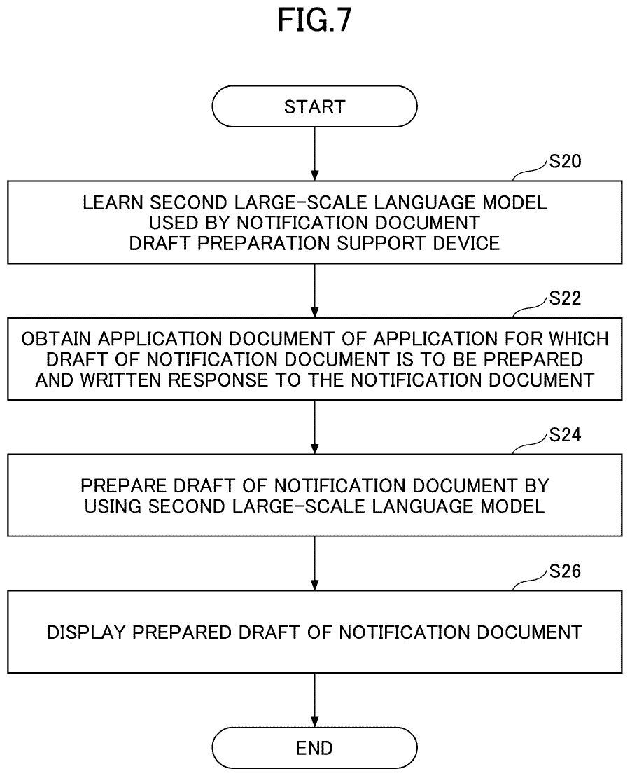

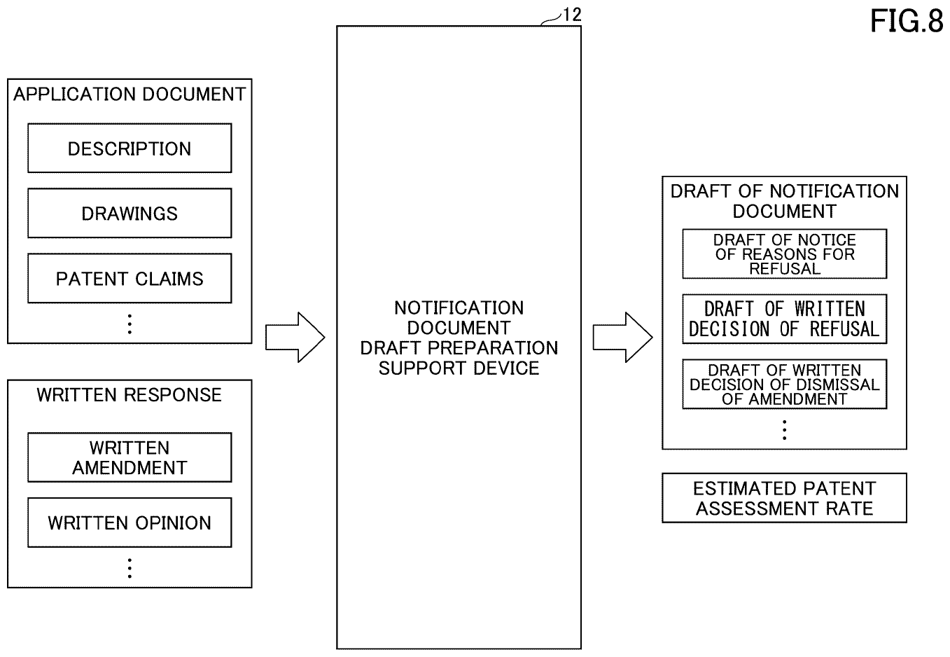

FIG. 7 is a flowchart of an example of processing by the notification document draft preparation support device 12 according to the present embodiment. FIG. 8 is an image diagram of an example of the processing by the notification document draft preparation support device 12 according to the present embodiment, to prepare a draft of a notification document.

In step S20, the learning part 64 of the notification document draft preparation support device 12 learns the learned large-scale language model 56 (an example of a second large-scale language model) to be used in the notification document draft preparation part 54. The learning part 64 makes the learned large-scale language model 56 learn a relationship between the application document, the notification document notified by the patent office side with respect to the application document, and the written response submitted by the applicant side with respect to the notification document, by using at least one of the information of examination standards, examination guidelines, court cases, or judicial precedents stored in the first database storage 40, and the information of the examination history of the past application stored in the second database storage 42. The learned large-scale language model 56 learns to output the draft of the notification document notified by the patent office side to the written response when the application document and the written response are input.

The processing of making the learned large-scale language model 56 learn in step S20 may be performed outside the notification document draft preparation support device 12. Furthermore, the first database storage 70 and the second database storage 72 may be provided outside the notification document draft preparation support device 12.

Furthermore, the processing for making the learned large-scale language model 56 learn in step S20 may be performed for each type of raised issue in the notification document after classifying the teaching data according to the type of raised issue in the notification document from the patent office. The type of raised issue in the notification document is one or a combination of novelty, inventive step, applicability to invention, industrial applicability, clarity, and support requirements.

When the patent office-side user operates the patent office-side user terminal 16 and designates an application for which a draft of the notification document is to be prepared, the notification document draft preparation part 54 of the notification document draft preparation support device 12 starts processing in step S22.

In step S22, the notification document draft preparation part 54 obtains the application document of the application for which a draft of the notification document is to be prepared and the written response with respect to the notification document from the patent office. In step S24, the notification document draft preparation part 54 prepares a draft of the notification document, for example, as illustrated in FIG. 8.

As illustrated in FIG. 8, the notification document draft preparation part 54 of the notification document draft preparation support device 12 prepares a draft of the notification document by using the learned large-scale language model 56, from both the application document and the written response obtained in step S22. The learned large-scale language model 56 outputs a draft of the notification document when the application document and the written response are input.

The application document obtained in step S22 includes, for example, a description, drawings, and patent claims. The written response with respect to the notification document from the patent office is, for example, at least either of a draft of written amendment or a written opinion. The written response with respect to the notification document from the patent office may include a cited document.

When the draft of the notification document prepared by the notification document draft preparation part 54 is notified to the applicant side, the assessment-rate estimator 58 of the notification document draft preparation support device 12 may estimate an assessment rate (estimated patent assessment rate in FIG. 8) such as a patent assessment rate by a subsequent procedure by using the learned assessment-rate estimation model 60.

In step S26, the display controller 62 of the notification document draft preparation support device 12 causes the patent office-side user terminal 16 to display the draft of the notification document prepared in step S24. The display controller 62 may also cause the estimated patent assessment rate estimated by the assessment-rate estimator 58 to be displayed. The patent-related document preparation support system 1 according to the present embodiment can reduce the knowledge and effort required of a patent office-side user to prepare a draft of a notification document.

### [Another Embodiment]

The patent-related document preparation support system 1 according to the present embodiment may utilize a combination of processes of the written response draft preparation support device 10 and the notification document draft preparation support device 12. For example, the written response draft preparation support device 10 may prepare a draft of a written response based on the application document of the application for which the draft of the written response is to be prepared and the draft of the notification document prepared by the notification document draft preparation support device 12.

For example, the notification document draft preparation support device 12 may prepare a draft of a notification document, based on the application document of the application for which the draft of the notification document is to be prepared and the draft of the written response prepared by the written response draft preparation support device 10.

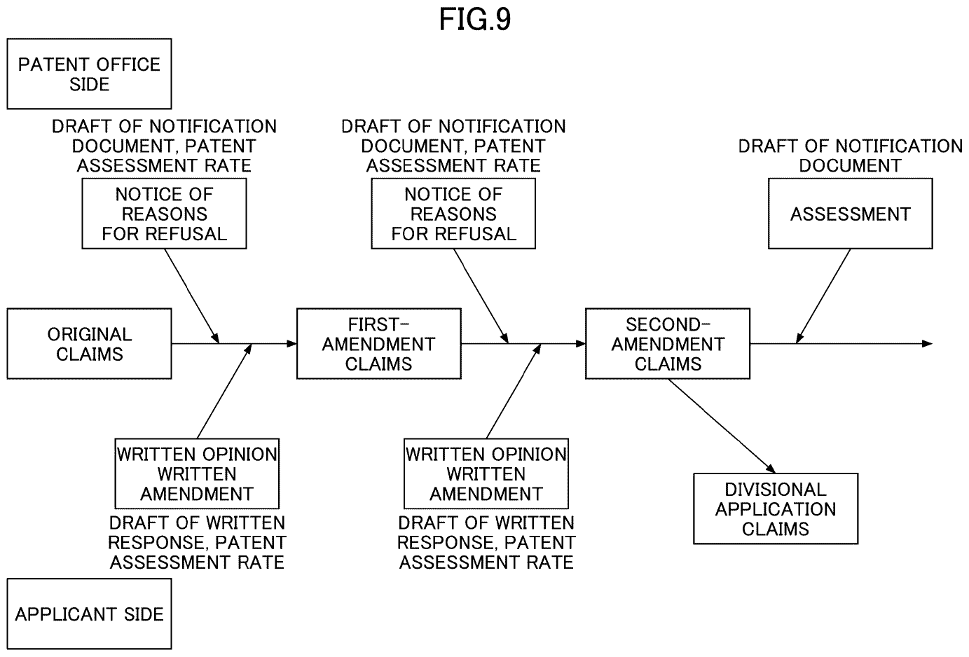

Thus, by utilizing a combination of processes of the written response draft preparation support device 10 and the notification document draft preparation support device 12, the patent-related document preparation support system 1 according to the present embodiment can estimate future responses of the applicant side and the patent office side by combining the draft of the notification document from the patent office side and the draft of the written response from the applicant side, as illustrated in FIG. 9, for example. Furthermore, the written response draft preparation part 24 may prepare a draft claim to be filed in a divisional application.

The assessment-rate estimator 28 of the written response draft preparation support device 10 may be omitted. The assessment-rate estimator 58 of the notification document draft preparation support device 12 may be omitted. Furthermore, the learned large-scale language models 26 and 56 may be trained for each type of rebuttal to the notification document after classifying the teaching data according to the type of rebuttal with respect to the notification document from the patent office (for example, a policy of not limiting the scope of rights, or a a policy of pursuing rights even if the scope of rights is limited, etc.).

Although the embodiments have been described above, it will be understood that various changes in form and details can be made without departing from the spirit and scope of the claims.

Although the present invention has been described above based on the embodiments, the present invention is not limited to the above embodiments, and various modifications can be made within the scope of the claims. The present application claims priority to Japanese Patent Application No. 2023-072002 filed with the Japan patent office on Apr. 26, 2023, and the entire contents thereof are incorporated herein by reference.

### REFERENCE SIGNS LIST

1 Patent-related document preparation support system
10 Written response draft preparation support device
12 Notification document draft preparation support device
14 Applicant-side user terminal
16 Patent office-side user terminal
18 Communication network
24 Written response draft preparation part
26, 56 Learned large-scale language model
28, 58 Assessment-rate estimator
30, 60 Learned assessment-rate estimation model
32, 62 Display controller
34, 64 Learning part
40, 70 First database storage
42, 72 Second database storage
54 Notification document draft preparation part
500 Computer

1. A notification document draft preparation support device for supporting preparation work of a patent-related document, the notification document draft preparation support device comprising:
a memory;
a processor connected to the memory;
a first database configured to store at least one of information on examination standards, examination guidelines, court cases, or judicial precedents; and
a second database configured to store information on an examination history of an application, wherein
the processor is configured to:
prepare a draft of a notification document to be sent from a patent office, based on an application document and a written response which are newly obtained, by using a learned large-scale language model which has learned a relationship between an application document, a notification document from the patent office, and a written response with respect to the notification document which are included in information on an examination history; and
display the prepared draft.

2. The notification document draft preparation support device according to claim 1, wherein
the processor is configured to cause the large-scale language model to learn the relationship between the application document, the notification document from the patent office, and the written response with respect to the notification document, included in the information on the examination history, after classification based on a type of raised issue in the notification document from the patent office.

3. The notification document draft preparation support device according to claim 2, wherein
the type of raised issue is one or a combination of novelty, inventive step, applicability to invention, industrial applicability, clarity, and support requirements.

4. (canceled)

5. (canceled)

6. (canceled)

7. A patent-related document preparation support system provided with a written response draft preparation support device and a notification document draft preparation support device which are for supporting preparation work of a patent-related document, the patent-related document preparation support system comprising:
a memory;
a processor connected to the memory;
a first database configured to store at least one of information on examination standards, examination guidelines, court cases, or judicial precedents; and
a second database configured to store information on an examination history of an application, wherein;
the processor is configured to:
prepare a draft of a written response based on a newly obtained application document and a notification document from a patent office, by using a first large-scale language model which has learned a relationship between an application document, a notification document from a patent office, and a written response with respect to the notification document which are included in the information on the examination history;
prepare a draft of a notification document to be sent from the patent office, based on an application document and a written response which are newly obtained, by using a second learned large-scale language model that has learned the relationship between the application document, the notification document from the patent office, and the written response with respect to the notification document which are included in the information on the examination history;
display the prepared draft; and
prepare a draft of a written response from both the application document and the draft of the notification document from the patent office, which are newly obtained.

8. The patent-related document preparation support system according to claim 7, wherein
the processor is configured to prepare a draft of a notification document to be sent from the patent office, based on the application document and the draft of the written response, which are newly obtained.

9. (canceled)

10. A notification document draft preparation support method performed by a notification document draft preparation support device supporting preparation work of a patent-related document, the notification document draft preparation support device being provided with a first database storing at least one of information on examination standards, examination guidelines, court cases, or judicial precedents, and a second database storing information on an examination history of an application, the notification document draft preparation support method comprising:
preparing a draft of a notification document to be sent from a patent office based on an application document and a written response which are newly obtained, by using a learned large-scale language model which has learned a relationship between an application document, a notification document from the patent office, and a written response with respect to the notification document which are included in information on an examination history; and
displaying the prepared draft.

11. (canceled)

12. A non-transitory computer-readable recording medium having a program embodied therein for causing a computer functioning as a notification document draft preparation support device to perform a procedure for supporting preparation work of a patent-related document, the notification document draft preparation support device being provided with a first database storing at least one of information on examination standards, examination guidelines, court cases, or judicial precedents, and a second database storing information on an examination history of an application, the procedure comprising:
preparing a draft of a notification document to be sent from the patent office, based on an application document and a written response which are newly obtained, by using a large-scale language model which has learned a relationship between an application document, a notification document from the patent office, and a written response with respect to the notification document which are included in the information on the examination history, and
displaying the prepared draft.
